(19) United States
(12) Patent Application Publication
(10) Pub. No.: US 2026/0260606 A1
(43) Pub. Date: Sep. 3, 2026

(54) DISPLAY APPARATUS AND METHOD OF CONTROLLING THE SAME

(71) Applicant: LX Semicon Co., Ltd., Daejeon (KR)

(72) Inventors: Sang Kwon KIM, Daejeon (KR); Harry CHO, Daejeon (KR); Yun Tae LEE, Daejeon (KR)

(73) Assignee: LX Semicon Co., Ltd., Daejeon (KR)

(21) Appl. No.: 19/554,284

(22) Filed: Mar. 2, 2026

(30) Foreign Application Priority Data
Feb. 28, 2025 (KR) 10-2025-0026812

(51) Int. Cl. G09G 3/3225

(52) U.S. Cl. CPC G09G 3/3225; G09G 2310/04; G09G 2320/0233; G09G 2320/043; G09G 2320/06

(57) ABSTRACT

The present application relates to a display apparatus and a method of controlling the same. A display apparatus according to one embodiment of the present disclosure includes a controller which compensates data of each pixel according to at least one compensation mode of a first compensation mode in which data of each pixel is compensated in units of a plurality of blocks in which the plurality of pixels are grouped and a second compensation mode in which data of a corresponding pixel is compensated for each pixel and a memory which stores the plurality of blocks and a representative value corresponding to each of the blocks.

### CROSS-REFERENCE TO RELATED APPLICATIONS

This application claims the benefit of the Korean Patent Application No. 10-2025-0026812 filed on February 28, 2025, which are hereby incorporated by reference as if fully set forth herein.

### BACKGROUND

### Field of the Invention

The present disclosure directly or indirectly relates to a technology of compensating data supplied to a pixel. For example, the present disclosure may be applied to display products such as an organic light emitting diode (OLED) and the like but is not limited thereto.

### Discussion of the Related Art

An electroluminescence display apparatus is driven with a quick response speed and low power consumption using a light emitting diode (LED) or organic light emitting diode (OLED) that generates light through recombination of electrons and holes.

For example, an OLED includes an anode electrode, a cathode electrode, and a light emitting layer disposed between the anode electrode and the cathode electrode and emits light according to a current flowing from the anode electrode to the cathode electrode.

Generally, in an electroluminescence display apparatus, pixels are stressed and degraded according to a driving current. The more stressed a pixel is, the severer the degrade becomes, and thus color distortion, luminance drop and luminance nonuniformity between pixels in different locations increase and cause a problem of degrading quality of a display image.

Meanwhile, according to the conventional technology, since a large OLED display stores and processes compensation data of each pixel of an entire screen to compensate for changes in characteristics of pixels (such as degradation and deviation of an component such as a thin film transistor (TFT) and a diode), the large OLED display has a problem of using many memories.

### SUMMARY

One embodiment of the present disclosure is for solving the above problems and is directed to minimizing use of a memory by dividing an entire region of a display panel into specific regions in units of blocks and compensating a corresponding block using a representative value.

In addition, one embodiment of the present disclosure is directed to providing a solution for efficiently using a memory and improving compensation accuracy at the same time by selectively switching between compensation in units of blocks and compensation in units of pixels on the basis of a state of a display panel which varies according to a change in time and applying the switched compensation.

A display apparatus according to one aspect of the present disclosure includes a controller which compensates data of each pixel according to at least one compensation mode of a first compensation mode in which data of each pixel is compensated in units of a plurality of blocks in which the plurality of pixels are grouped and a second compensation mode in which data of a corresponding pixel is compensated for each pixel and a memory which stores the plurality of blocks and a representative value corresponding to each of the blocks. In addition, in operation in the first compensation mode, the controller compensates data of the pixels in the block using the representative value corresponding to each of the blocks stored in the memory, and in operation in the second compensation mode, the controller compensates data of pixels which are not included in the block using a compensation value of each pixel.

A method of controlling a display apparatus according to another aspect of the present disclosure includes generating AxB blocks each including a first pixel of a display panel, generating CxD blocks each including a second pixel of the display panel (each of A, B, C, and D is a natural number, A and C are equal to as or different from each other, and B and D are also equal to or different from each other), storing a representative value corresponding to each of the plurality of generated blocks in a memory, determining whether a specific pixel is included in the blocks, and compensating data supplied to the specific pixel using the representative value stored in the memory when the specific pixel is included in any one of the blocks.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure. In the drawings:

FIG. 1 is a view showing a configuration of an organic light emitting display apparatus according to one embodiment of the present disclosure;

FIG. 2 is a block diagram illustrating a compensation module in more detail according to one embodiment of the present disclosure;

FIG. 3 is a view illustrating one example in which pixels included in a display panel are generated as a specific block according to one embodiment of the present disclosure;

FIG. 4 is a view illustrating another example in which pixels included in a display panel are generated as a specific block according to one embodiment of the present disclosure;

FIG. 5 is a view for describing a process of grouping pixels having the same brightness in a compensation mode for each block according to one embodiment of the present disclosure;

FIG. 6 is a view illustrating a process of switching between a compensation mode for each block and a compensation mode for each pixel when a specific condition is satisfied according to one embodiment of the present disclosure; and

FIG. 7 is a flowchart illustrating a method of controlling the display apparatus according to one embodiment of the present disclosure.

### DETAILED DESCRIPTION OF THE DISCLOSURE

Advantages and features of the present disclosure and methods of achieving the same will become apparent with reference to the accompanying drawings and the following detailed embodiments. However, the present disclosure is not limited to embodiments to be disclosed below but may be implemented in various different forms, the embodiments are provided so that the present disclosure is completely implemented and provided to fully explain the scope of the present disclosure for those skilled in the art, and the scope of the present disclosure is defined by the appended claims.

Like reference numerals refer to substantially the same components throughout the specification. In the following description, detailed description of components which are not related to core components of the present disclosure and components and functions which are known in the art of the present disclosure may be omitted.

When the terms “comprise,” “include,” “be formed of,” and the like are used in the present specification, other components may be added thereto unless “only” is used. A case in which a component is expressed in a singular form includes a case in which the component is provided as a plurality of components unless otherwise explicitly stated.

When a component is interpreted, it will be interpreted as including an error range even when there is no separate explicit description.

Although terms such as “first,” “second,” and the like may be used for describing various components, the components are not limited by the terms. The terms are only used to distinguish one component from another component. Accordingly, a first component to be mentioned below may also be a second component in a technical spirit of the present disclosure.

The term “at least one” should be understood to include all possible combinations from one or more related items. For example, “at least one of a first item, a second item, and a third item” may mean not only the first item, the second item, or the third item, but also all possible combinations of two or more items among the first item, the second item, and the third item.

Features of various embodiments of the present disclosure may be partially or entirely coupled or combined and operated and driven in cooperation in various technical ways, and the embodiments may also be implemented independently of each other or implemented together in conjunction with each other.

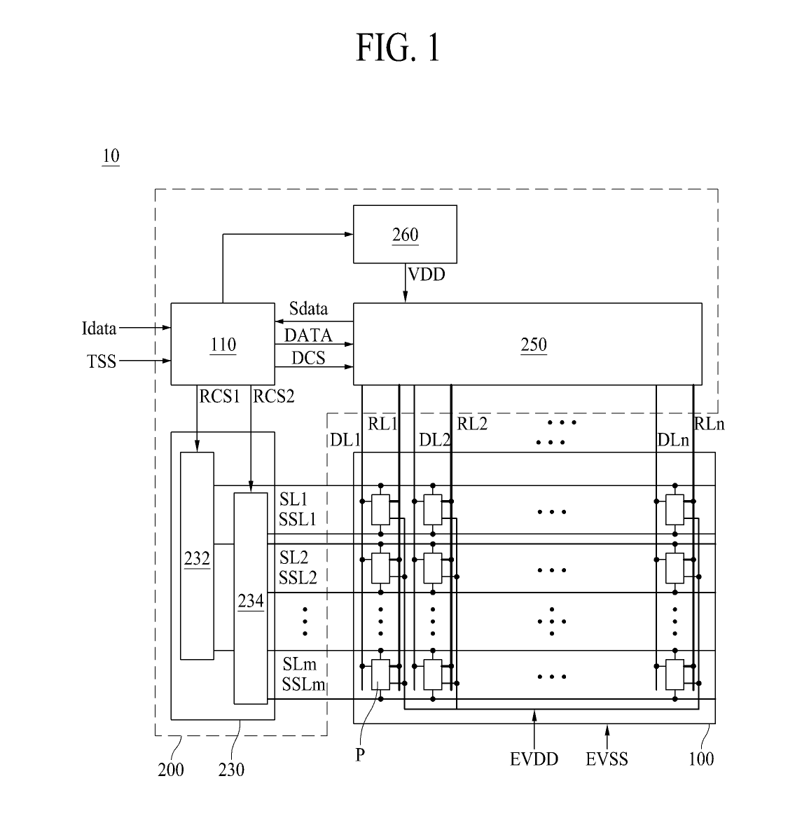

FIG. 1 is a view showing a configuration of an organic light emitting display apparatus according to one embodiment of the present disclosure.

Referring to FIG. 1, an organic light emitting display apparatus 10 according to one embodiment of the present disclosure includes an organic light emitting display panel 100 and a driving device 200.

The organic light emitting display panel 100 includes first to m^{th} (here, m is a natural number) scan lines SL1 to SLm, first to m^{th} sensing lines SSL1 to SSLm, first to n^{th} (here, n is a natural number greater than m) data lines DL1 to DLn, first to n^{th} reference lines RL1 to RLn, and a plurality of pixels P.

The first to m^{th} scan lines SL1 to SLm are disposed in parallel to be spaced a predetermined distance from each other in a first direction, for example, a horizontal direction of the organic light emitting display panel 100. The first to m^{th} sensing lines SSL1 to SSLm are disposed in parallel to be spaced a distance from the scan line SL1 to SLm, respectively.

The first to n^{th} data lines DL1 to DLn are disposed in parallel to be spaced a predetermined distance from each other in a second direction, for example, a vertical direction of the organic light emitting display panel 100 to intersect the scan lines SL1 to SLm and the sensing lines SSL1 to SSLm. The first to n^{th} reference lines RL1 to RLn are disposed in parallel to be spaced a predetermined distance from the data lines DL1 to DLn, respectively.

The first to n^{th} reference lines RL1 to RLn are individually connected to pixels P formed on horizontal lines corresponding to a longitudinal direction of the scan lines SL1 to SLm and commonly connected to pixels P formed on vertical lines corresponding to a longitudinal direction of the data lines DL1 to DLn. That is, each of the first to n^{th} reference lines RL1 to RLn is commonly connected to the pixels P formed on a pixel column of the organic light emitting display panel 100 and is individually connected to one of the pixels P formed on pixel rows of the organic light emitting display panel 100.

Each of the plurality of pixels P is formed in each pixel region defined by one of the first to m^{th} scan lines SL1 to SLm and one of the first to n^{th} data lines DL1 to DLn, which intersect each other. In this case, each of the plurality of pixels P may be any one of a red pixel, a green pixel, a blue pixel, and a white pixel. Adjacent i (here, i is a natural number of 3 or more) pixels of the plurality of pixels P may constitute one unit pixel which displays one image. For example, each unit pixel may include a red pixel, a green pixel, a blue pixel, and a white pixel which are adjacent each other or include a red pixel, a green pixel, and a blue pixel which are adjacent to each other.

In addition, the driving device 200 illustrated in FIG. 1 operates the organic light emitting display panel 100 in an operation mode of the organic light emitting display panel 100. In one embodiment, the driving device 200 operates the organic light emitting display panel 100 in the operation mode of a sensing mode or display mode.

The sensing mode is the operation mode for detecting a threshold voltage (Vth) which is an electrical characteristic of a driving transistor (Tdr) of each pixel. The sensing mode may be performed in every preset periods, power-on periods of the organic light emitting display apparatus 10, power-off periods of a power source of the organic light emitting display apparatus 10, power-on periods of the power source after a set driving time, or power-off periods of the power source after a set driving time. For example, the sensing mode may be performed in the power-off period in which a user is not watching an image.

The display mode is the operation mode for compensating a data voltage supplied to each of the pixels P on the basis of electrical characteristics of the corresponding pixels P detected in the sensing mode and displaying an image on the pixels P. In this case, since each of the pixels P may be driven by the data voltage supplied to the corresponding pixel P, the data voltage may be referred to as a driving voltage. Hereinafter, the data voltage and the driving voltage will be interchangeably used for the sake of convenience in the description.

The driving device 200 includes a timing controller 210, a gate driver 230, and a data driver 250.

The timing controller 210 operates the gate driver 230 and the data driver 250 in the sensing mode or the display mode on the basis of a power-on/off signal input from an external system or a vertical synchronization signal of a timing synchronization signal TSS. The timing synchronization signal TSS may include the vertical synchronization signal, a horizontal synchronization signal, a data enable signal, and a clock signal.

Specifically, in the sensing mode, the timing controller 210 generates pixel data DATA for sensing the threshold voltage (Vth) of the driving transistor (Tdr) of each pixel by operating the driving transistor (Tdr) of each of the pixels P in a source follower mode and control signals DCS, RCS1, and RCS2. The pixel data DATA for sensing may have a grayscale value corresponding to a set target voltage for operating the driving transistor (Tdr) in the source follower mode.

In the display mode, the timing controller 210 generates compensation data on the basis of sensing data Sdata provided from the data driver 250 for each of the pixels P, compensates first pixel data Idata input from the external system (or graphic card) with the compensation data of a corresponding pixel to generate second pixel data DATA of each of the pixels P. In this case, the sensing data Sdata may be the threshold voltage (Vth) or mobility of the driving transistor (Tdr) of each pixel.

The timing controller 210 provides the generated second pixel data DATA of each of the pixels P to the data driver 250. The timing controller 210 generates the data control signal DCS for controlling the data driver 250 on the basis of the timing synchronization signal TSS, transmits the data control signal DCS to the data driver 250, generates first and second row control signals RCS1 and RCS2 for controlling the gate driver 230, and transmits the first and second row control signals RCS1 and RCS2 to the gate driver 230.

In FIG. 1, reference numeral 232 denotes a scan line driving unit, reference numeral 234 denotes a sensing line driving unit, reference numeral 260 denotes a power supply unit, EVDD shown in FIG. 1 denotes a high-level driving voltage, EVSS shown in FIG. 1 denotes a low-level driving voltage, and VDD shown in FIG. 1 denotes a power supply voltage.

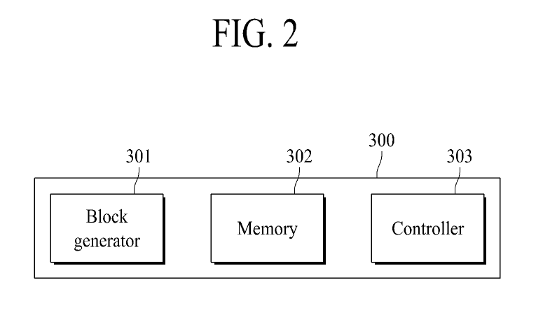

Meanwhile, the timing controller 210 illustrated in FIG. 1 may further include a compensation module and will be described in more detail with reference to FIG. 2.

FIG. 2 is a block diagram illustrating the compensation module in more detail according to one embodiment of the present disclosure.

A compensation module 300 which compensates data supplied to a pixel according to one embodiment of the present disclosure includes a block generator 301, a memory 302, a controller 303, and the like. However, the present disclosure is not limited thereto, and it is possible for those skilled in the art to omit, change, and add some components illustrated in FIG. 2.

The block generator 301 generates AxB blocks each including first pixels and CxD blocks each including second pixels.

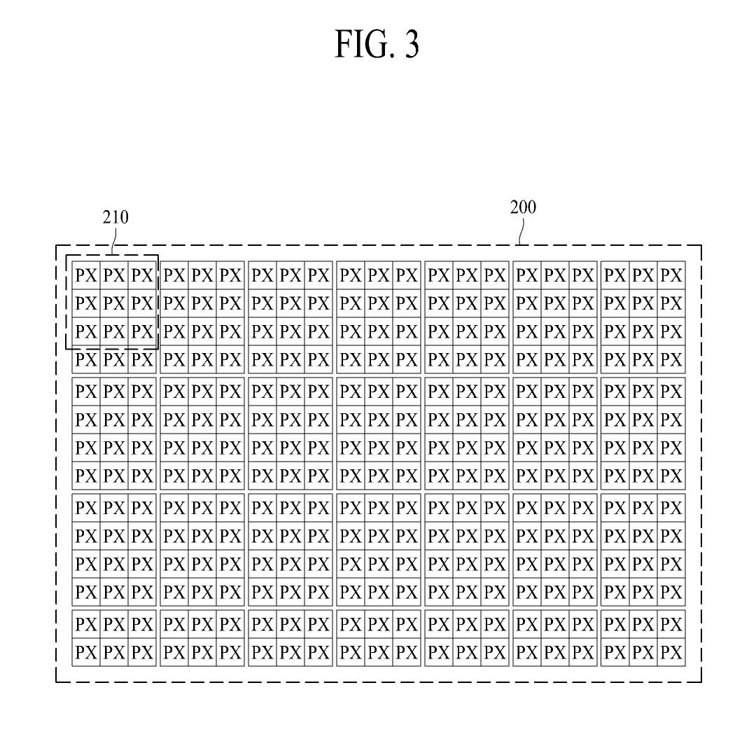

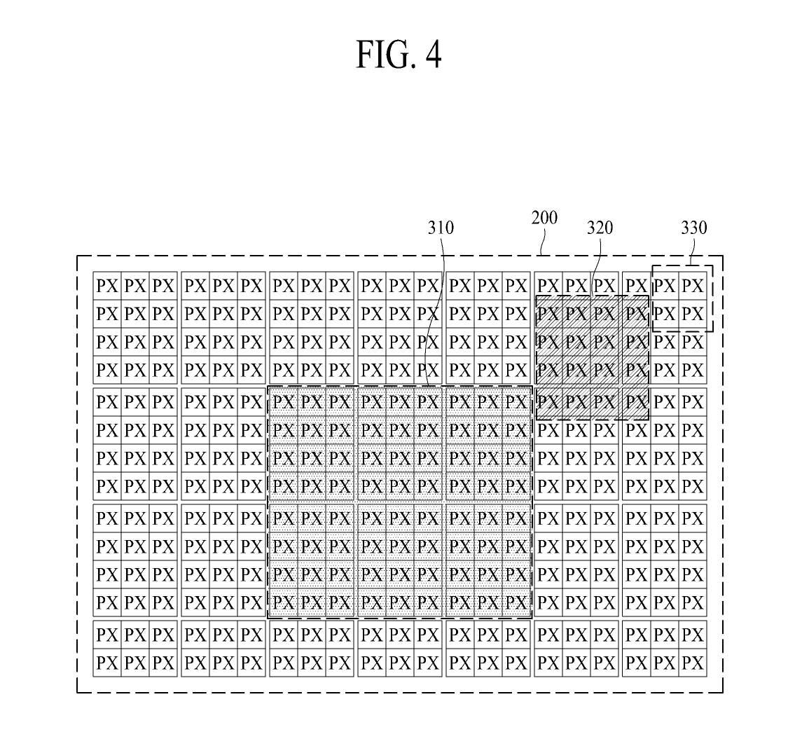

In this case, each of A, B, C, and D is a natural number, and A and C are equal to or different from each other. In addition, B and D are also equal to or different from each other. More specific examples about the block generator 301 will be described in more detail below with reference to FIGS. 3 and 4.

The memory 302 stores a representative value corresponding to each of a plurality of blocks generated by the block generator 301.

In addition, the controller 303 determines whether a specific pixel is included in the above-described blocks.

In this case, when the specific pixel is included in any one of the above-described blocks, the controller 303 compensates data supplied to the specific pixel using the representative value stored in the memory 302. In the present disclosure and the present specification, this may be referred to as a “first compensation mode” or “compensation mode for each block.” That is, in the first compensation mode (compensation mode for each block), data of each pixel is compensated in units of the plurality of blocks in which a plurality of pixels are grouped.

However, when a specific pixel is not included in any one of the above-described blocks, the controller 303 compensates data supplied to the specific pixel using a specific value mapped at the specific pixel. In the present disclosure and the present specification, this may be referred to as a “second compensation mode” or “compensation mode for each pixel.” That is, in the second compensation mode (compensation mode for each pixel), data of a corresponding pixel is compensated using a compensation value of each pixel which is not included in the blocks.

Meanwhile, in the second compensation mode is performed, data of a corresponding pixel is compensated using initial compensation data of each pixel (stored in the memory) obtained at a mass production time of the display apparatus and renewed compensation data.

The reason why the renewed compensation data is additionally used is that, when the display apparatus is used for a long time, a driving thin film transistor (TFT) is degraded. When the driving TFT is degraded, a threshold voltage (Vth) is shifted, and when the threshold voltage (Vth) is shifted, a gate voltage for turning the driving TFT on increases. The gate voltage is a data voltage input by a source driver integrated circuit (SDIC), and accordingly, the data voltage input by the SDIC is additionally required to be compensated.

FIG. 3 is a view illustrating one example in which pixels included in a display panel are generated as a specific block according to one embodiment of the present disclosure.

As illustrated in FIG. 3, a display panel 200 includes the plurality of pixels.

PX shown in FIG. 3 denotes a pixel.

According to one embodiment of the present disclosure, it may be designed that each block, which is a target of the compensation mode for each block, equally includes 3x3 pixels 210. That is, all the pixels in the display panel 200 are grouped in the blocks of the same size.

In this case, compensation values for the all pixels are not stored in the memory, and only a compensation value for a pixel located at a central point of the pixels 210 included in each of the blocks is stored as a representative value in the memory. Accordingly, a technical effect of efficiently using the memory is expected.

A more specific example will be described. In a mass production process, a camera apparatus captures a test image (having, for example, grayscale values of 32, 64, and 128) output by the display panel, and the memory stores only a representative value of each block without storing information about all pixels.

In this case, the representative value of each block may be, for example, a brightness value of a pixel located at a center of a block (however, an average value or the like of brightness values of all the pixels in the block may be used instead of the brightness value of the pixel located at the center.).

In addition, brightness values of the other pixels in the block may be estimated according to distances from the pixel located at the center.

Meanwhile, in FIG. 3, an example, in which the number of pixels 210 included in the block is 9 (3X3), is illustrated. A criterion for grouping into blocks each including 9 pixels may be determined according to, for example, a memory capacity, or blocks each having pixels in which differences in brightness value between pixels are 10% or less may be determined as groups.

However, the number of pixels 210 included in the block may be increased or decreased.

As the number of pixels 210 included in the block increases to more than 9 illustrated in FIG. 3, there is a technical effect of decreasing the number of representative values.

However, the present disclosure is not necessarily limited thereto, and another example will be described below with reference to FIG. 4.

FIG. 4 is a view illustrating another example in which pixels included in a display panel are generated as a specific block according to one embodiment of the present disclosure.

According to another embodiment of the present disclosure, one display panel includes regions 310 and 320 on which a compensation mode for each block is performed and a region 330 on which a compensation mode for each pixel is performed at the same time.

In addition, the numbers of pixels included in a first region 310 and a second region 320 on which the compensation mode for each block is performed may be set differently.

In FIG. 4, an example in which the compensation mode for each block is performed on the first region 310 and the second region 320 and the compensation mode for each pixel is performed on a third region 330 at the same time is illustrated, and compensation for blocks having the same size or different sizes or compensation for pixels may be performed on the remaining blocks other than the first region 310, the second region 320, and the third region 330 illustrated in FIG. 4.

The reason why the compensation mode for each pixel is performed on the third region 330 is that there is a problem of image quality due to characteristics of each pixel when the compensation mode for each block is performed. Accordingly, a unique compensation value is stored to match a compensation value of each block.

However, it is designed that arbitrary pixels included in the first region 310 and the second region 320 are compensated using representative values of blocks stored in the memory. The reason is that characteristics of compensation data are similar such that there is no problem of image quality even when the compensation mode for each block is performed.

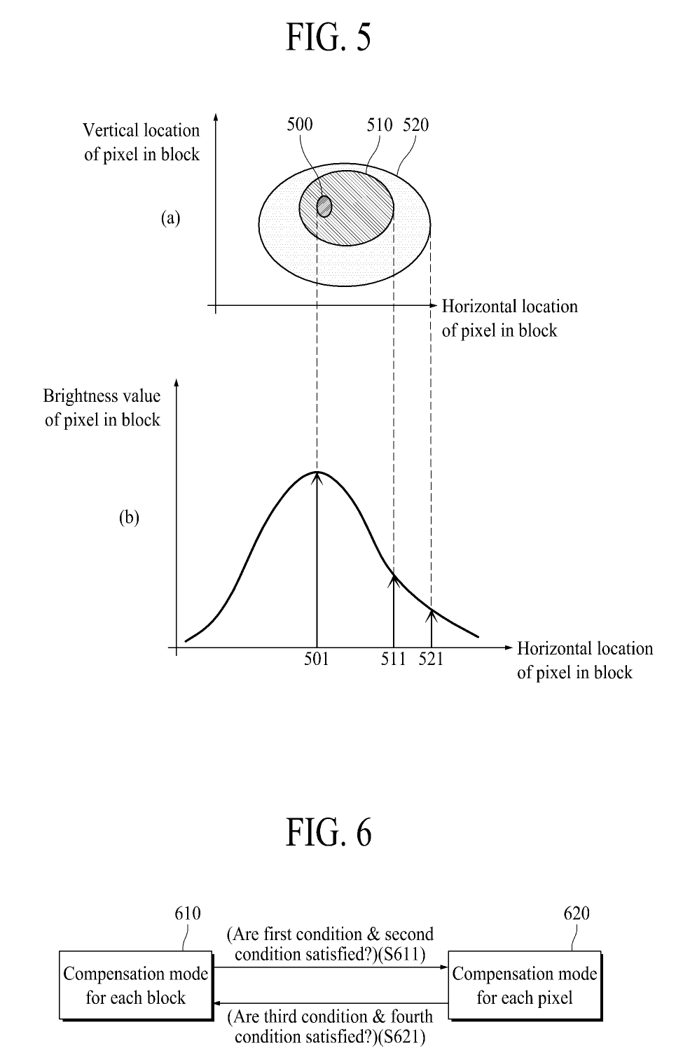

FIG. 5 is a view for describing a process of grouping the pixels having the same brightness in the compensation mode for each block according to one embodiment of the present disclosure.

According to one embodiment of the present disclosure, for example, a brightness value which is inversely proportional to a distance between a location of a specific pixel and a center point of each block may be estimated.

As a more specific example, a first point 500 in (a) of FIG. 5 denotes a pixel having a greatest brightness value 501 as illustrated in (b) of FIG. 5.

Meanwhile, pixels located in a first circle 510 in (a) of FIG. 5 have a median brightness value 511 as illustrated in (b) of FIG. 5.

In addition, pixels located in a second circle 520 in (a) of FIG. 5 have a smallest brightness value 521 as illustrated in (b) of FIG. 5.

That is, as pixels are away from the pixel having the greatest brightness value in the block, the pixels have small brightness value. Accordingly, interpolation may be performed through a method of estimating a pixel value which is inversely proportional to a distance based on the representative value 501 in the block.

FIG. 6 is a view illustrating a process of switching between a compensation mode for each block and a compensation mode for each pixel when a specific condition is satisfied according to one embodiment of the present disclosure.

According to still another embodiment of the present disclosure, a compensation mode for each block is not continuously performed in a specific region of a display panel, and when an arbitrary condition is satisfied, a compensation mode 610 for each block and a compensation mode 620 for each pixel may be switched.

First, it is assumed that the compensation mode 610 for each block is performed. In this case, when one or more of a first condition and a second condition are satisfied (S611), the compensation mode for each block is stopped and switched to the compensation mode 620 for each pixel.

The first condition will be described first.

For example, an apparatus according to one embodiment of the present disclosure recalculates a degradation level of each of a plurality of blocks in which a compensation mode for each block is performed. This may be performed by a controller 303 illustrated in FIG. 2.

As time, in which the apparatus (such as a liquid crystal display (LCD), an organic light emitting diode (OLED), a light emitting diode (LED), or a micro light emitting diode (MLED)) according to one embodiment of the present disclosure is used, goes by, pixels are stressed and degraded by a driving current. The more stressed a pixel is, the severer the degradation is, and the severer brightness drop is.

For example, it is assumed that the number of total pixels included in a block to which a compensation mode for each block is applied is 100.

In this case, calculating of a degradation level of each block is to count the number of pixels which are included in the corresponding block and of which degradation becomes severe such that the compensation mode for each block may not be applied thereto. That is, when the above-described interpolation is applied based on a representative value of the corresponding block, it is determined that whether the number of pixels in which a problem of image quality occurs is greater than a preset threshold value.

For example, when the number of pixels in which degradation is severe in a corresponding block is 5 or less, the compensation mode for each block is maintained.

However, when the number of pixels in which degradation is severe in a corresponding block is greater than 5, the compensation mode for each block is stopped.

The threshold value (ex: 5 in a block) related to the degradation level calculation is only exemplary. Although the threshold value is determined at a mass production of an initial product, the threshold value may be designed such that a degradation level is recalculated according to a predetermined use period (ex: one week, one month, one year, or the like) of the product and the compensation mode for each block is switched to the compensation mode for each pixel.

That is, when the number of pixels, which are included in a block and may not be compensated through compensation in units of blocks, is a preset number or more, the controller 303 stops the designation of the corresponding block and performs the compensation mode 620 for each pixel.

For example, a brightness value of a pixel disposed at a center of the corresponding block may be set to 100 (representative value).

In this case, when a brightness value of an arbitrary pixel in the corresponding block differs from the representative value by 10% or more, and the number of pixels in which such differences occur exceeds 5% of the number of total pixels in the corresponding block, it is switched to the compensation mode 620 for each pixel. However, it is possible that the compensation mode for each block is not stopped on the entire corresponding block, the compensation mode for each block is switched to the compensation mode for each pixel on only pixels having problems in the corresponding block, and the compensation mode for each block is maintained for the remaining pixels.

Next, the second condition will be described.

For example, the controller 303 of the apparatus according to one embodiment of the present disclosure determines an available space of a memory 302. In addition, in the determination result, when the available space of the memory has a size of a preset value or more, the controller 303 stops a designation of at least one of blocks (such as AxB blocks and CxD blocks) and performs the compensation mode 620 for each pixel.

Meanwhile, it is assumed that the compensation mode 620 for each pixel is performed. In this case, when one or more of the third condition and the fourth condition are satisfied (S621), the compensation mode for each pixel is switched to the compensation mode 610 for each block. In this case, the third condition means, for example, an opposite situation of the above-described first condition, and the fourth condition means, for example, an opposite situation of the above-described second condition.

That is, such a time variable compensation technology according to one embodiment of the present disclosure has following technical effects.

Since, according to the preset conditions, an arbitrary region of a display panel, which has been operated in the compensation mode for each pixel, may be operated in the compensation mode for each block, or, conversely, another arbitrary region of the display panel, which has been operated in the compensation mode for each block, may be operated in the compensation mode for each pixel, advantages of improving both memory performance and compensation accuracy are expected.

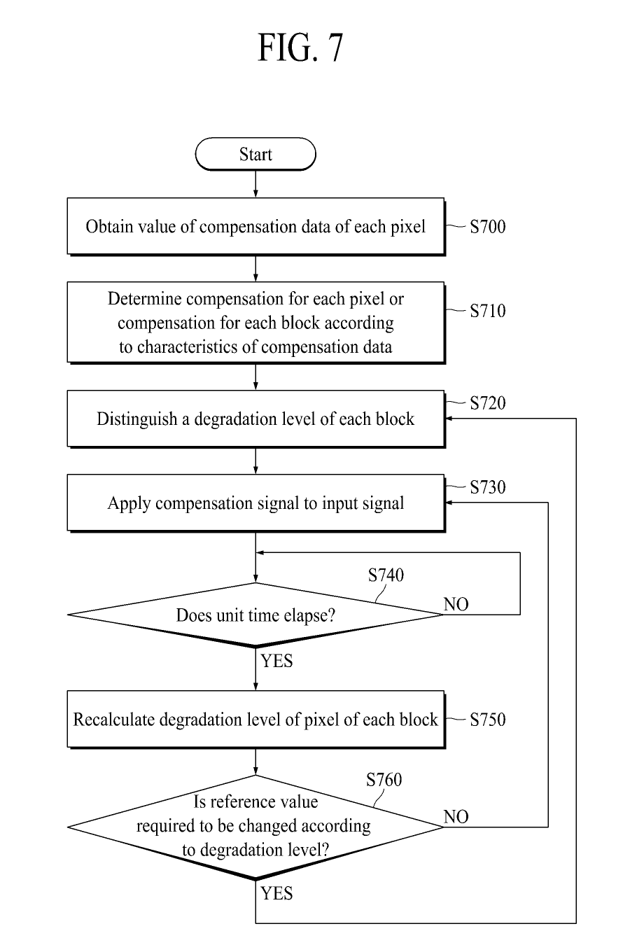

FIG. 7 is a flowchart illustrating a method of controlling the display apparatus according to one embodiment of the present disclosure.

The display apparatus according to one embodiment of the present disclosure obtains compensation data of each pixel (S700). This may be performed during an initial production process of a product but is not necessarily limited thereto. Even when a user purchases and uses the display apparatus, the display apparatus according to one embodiment of the present disclosure may also regularly or irregularly obtain the compensation data of each pixel.

In addition, the display apparatus determines whether compensation for each pixel is performed or compensation for each block is performed for each region of the display panel according to characteristics of the compensation data (S710). A specific embodiment related thereto has been described with reference to FIG. 4. That is, according to one embodiment of the present disclosure, compensation for each block may be performed in all regions of the display panel, or compensation for each block may be performed in some regions, and compensation for each pixel may be performed in the other regions.

In addition, the display apparatus distinguishes a degradation level of each block (S720) and applies a compensation signal to an input signal (S730). Particularly, data supplied to each pixel is compensated on the basis of a representative value set to each block.

In addition, the display apparatus determines whether a preset unit time elapses (S740). Unlike the conventional technology, according to one embodiment of the present disclosure, a compensation condition may be changed according to a change in time.

That is, when the preset unit time elapses in a result of the determination (S740), the display apparatus recalculates a degradation level of a pixel included in each block (S750).

In addition, the display apparatus determines whether a reference value is required to be changed according to the degradation level of the pixel included in each block (S760).

For example, it is designed that, when the number of pixels, which are included in a specific block and may not be compensated through compensation in units of blocks, is a preset value or more, the compensation in units of blocks is not performed on the corresponding block any more and is switched to compensation in units of pixels.

Alternatively, it may be designed that, when an available space of the memory of the display apparatus has a size of a preset value or more, the compensation in units of blocks is not performed on at least one or more blocks and is switched to the compensation in units of pixels.

That is, briefly, according to one embodiment of the present disclosure, a method of compensating data supplied to a pixel will be described below.

An apparatus (which may be included in a time controller (T-CON) or implemented as a separate module) for compensating the data supplied to the pixel generates AxB blocks each including a first pixel of the display panel and CxD blocks each including a second pixel of the display panel.

In addition, the apparatus according to one embodiment of the present disclosure stores a representative value corresponding to each of the generated plurality of blocks in the memory and determines whether a specific pixel is included in the blocks.

In addition, when the specific pixel is included in any one of the blocks, the apparatus according to one embodiment of the present disclosure compensates data supplied to the specific pixel using the representative value stored in the memory.

In addition, briefly, the apparatus for compensating data supplied to a pixel according to one embodiment of the present disclosure will be described below with reference to FIG. 2.

The controller 303 compensates data of each pixel according to at least one compensation mode of a first compensation mode in which data of each pixel is compensated in units of a plurality of blocks in which a plurality of pixels are grouped and a second compensation mode in which data of a corresponding pixel is compensated for each pixel.

Meanwhile, the memory 302 stores the plurality of blocks and representative values corresponding to the blocks. In addition, as described above, a unit of the plurality of blocks may vary without being fixed.

In addition, the controller 303 may recalculate a degradation level of each plurality of blocks.

It is designed that, when the number of pixels, which are included in the block and may not be compensated in the first compensation mode, is a preset value or more, the controller 303 compensates the pixel included in the block in the second compensation mode instead of the first compensation mode.

In addition, the controller 303 may additionally determine an available space of the memory 302.

It is designed that, when the available space of the memory 302 has a size of a preset value or more in a result of the determination, the controller 303 compensates a pixel included in the block in the second compensation mode instead of the first compensation mode.

In addition, as described above, a function of the controller 303 illustrated in FIG. 2 may be performed by the timing controller 210 illustrated in FIG. 1.

According to one embodiment of the present disclosure, there is a technical effect of minimizing use of a memory by dividing a specific region in units of blocks in an entire region of a display panel and compensating a corresponding block using a representative value.

In addition, according to one embodiment of the present disclosure, a technical effect of efficiently using a memory and improving compensation accuracy at the same time are expected by monitoring a situation changed according to a change in time and switching between compensation in units of blocks and compensation in units of pixels.

However, effects which are not explicitly described in this specification can be understood by those skilled in the art through the gist of the entire present specification.

It will be understood by those skilled in the art that the present disclosure may be easily changed to other specific forms without changing the technological sprit or essential features.

Therefore, the above-described embodiments should be understood as only examples in all aspects and not for purposes of limitation. It should be interpreted that the scope of the present disclosure is defined not by the detailed description but by the appended claims and encompasses all modifications or alterations derived from meanings, the scope, and equivalents of the appended claims.

What is claimed is:

1. A display apparatus comprising:
a controller which compensates data of each pixel according to at least one compensation mode of a first compensation mode in which data of each pixel is compensated in units of a plurality of blocks in which the plurality of pixels are grouped and a second compensation mode in which data of a corresponding pixel is compensated for each pixel; and
a memory which stores the plurality of blocks and a representative value corresponding to each of the blocks,
wherein, in operation in the first compensation mode, the controller compensates data of the pixels in the block using the representative value corresponding to each of the blocks stored in the memory, and
in operation in the second compensation mode, the controller compensates data of pixels which are not included in the block using a compensation value of each pixel.

2. The display apparatus of claim 1, wherein, when the number of specific pixels, which are included in the block and of which brightness values differ from the representative value by a predetermined level or more, is a preset value or more:
the controller compensates only the specific pixels in the second compensation mode instead of the first compensation mode; and
the controller maintains the first compensation mode for the remaining pixels other than the specific pixels in the block.

3. The display apparatus of claim 1, wherein the controller determines an available space of the memory.

4. The display apparatus of claim 3, wherein, when the available space of the memory has a size of a preset value or more in the determination result, the controller compensates pixels included in some blocks in the second compensation mode instead of the first compensation mode.

5. The display apparatus of claim 1, wherein, in operation in the first compensation mode, the controller performs interpolation using the representative value of the block including the pixel and a distance of the pixel from a pixel located at a center of the block with reference to the memory.

6. The display apparatus of claim 1, wherein, when a first condition in which the number of pixels, which are included in the plurality of blocks and are not compensated in units of blocks, is a preset value or more is satisfied and a second condition in which a size of an available space of the memory is a preset value or more is also satisfied, the controller cancels a designation of a corresponding block and switches to a compensation mode for each pixel.

7. The display apparatus of claim 6, wherein, when a third condition in which the number of pixels, which are included in the plurality of blocks and are not compensated in units of blocks, is smaller than the preset value is satisfied and a fourth condition in which the size of the available space of the memory is smaller than the preset value is also satisfied, the controller returns to the compensation mode for each block.

8. A method of controlling a display apparatus, comprising:
storing a plurality of blocks and a representative value corresponding to each of the blocks; and
compensating data of each pixel according to at least one compensation mode of a first compensation mode in which data of each pixel is compensated in units of a plurality of blocks in which the plurality of pixels are grouped and a second compensation mode in which data of a corresponding pixel is compensated for each pixel,
wherein, in operation in the first compensation mode, a controller compensates data of the pixels in the block using the representative value corresponding to each of the blocks stored in the memory, and
in operation in the second compensation mode, the controller compensates data of pixels which are not included in the block using a compensation value of each pixel.

9. The method claim 8, further comprising, when the number of specific pixels, which are included in the block and of which brightness values differ from the representative value by a predetermined level or more, is a preset value or more:
compensating only the specific pixels in the second compensation mode instead of the first compensation mode; and
maintaining the first compensation mode for the remaining pixels other than the specific pixels in the block.

10. The method of claim 8, further comprising determining an available space of the memory.

11. The method of claim 10, further comprising, when the available space of the memory has a size of a preset value or more in the determination result, compensating pixels included in some blocks in the second compensation mode instead of the first compensation mode.

12. The method of claim 8, further comprising, in operation in the first compensation mode, performing interpolation using the representative value of the block including the pixel and a distance of the pixel from a pixel located at a center of the block with reference to the memory.

13. The method of claim 8, further comprising, when a first condition in which the number of pixels, which are included in the plurality of blocks and are not compensated in units of blocks, is a preset value of more is satisfied and a second condition in which a size of an available space of the memory is a preset value or more is also satisfied, canceling a designation of a corresponding block and switching to the compensation mode for each pixel.

14. The method of claim 13, further comprising, when a third condition in which the number of pixels, which are included in the plurality of blocks and are not compensated in units of blocks, is smaller than the preset value is satisfied and a fourth condition in which the size of the available space of the memory is smaller than the preset value is also satisfied, returning to the compensation mode for each block.

15. A method of controlling a display apparatus, comprising:
generating AxB blocks each including a first pixel of a display panel;
generating CxD blocks each including a second pixel of the display panel;
storing a representative value corresponding to each of the plurality of generated blocks in a memory;
determining whether a specific pixel is included in the blocks; and
compensating data supplied to the specific pixel using the representative value stored in the memory when the specific pixel is included in any one of the blocks.

16. The method of claim 15, further comprising, when the number of specific pixels, which are included in the block and of which brightness values differ from the representative value by a predetermined level or more, is a preset value or more:
compensating only the specific pixels in a second compensation mode instead of a first compensation mode; and
maintaining the first compensation mode for the remaining pixels other than the specific pixels in the block.

17. The method of claim 16, wherein:
the first compensation mode corresponds to a compensation mode for each block; and
the second compensation mode corresponds to a compensation mode for each pixel.

18. The method of claim 17, further comprising determining an available space of the memory.

19. The method of claim 18, further comprising, when the available space of the memory has a size of a preset value or more in the determination result, canceling a designation of at least one of the AxB blocks and the CxD blocks.

20. The method of claim 15, wherein the compensating further includes performing interpolation using the representative value of the block including the specific pixel and a distance of the specific pixel from a pixel located at a center of the block.
